(19) United States
(12) Patent Application Publication
(10) Pub. No.: US 2026/0238340 A1
(43) Pub. Date: Aug. 13, 2026

(54) REMOTE ALTERNATING CURRENT (AC) POWER CONTROL SYSTEM FOR CABLE NETWORK MAINTENANCE

(71) Applicant: Charter Communications Operating, LLC, St. Louis, MO (US)

(72) Inventors: Kevin Kwasny, Aurora, CO (US); Diana Linton, Parker, CO (US); Justin Stiles, Thornton, CO (US)

(21) Appl. No.: 19/051,131

(22) Filed: Feb. 11, 2025

(51) Int. Cl. H04B 10/079; H04B 3/46; H04B 10/032

(52) U.S. Cl. CPC H04B 10/0793; H04B 3/46; H04B 10/032; H04B 10/0791; H04B 2210/08

(57) ABSTRACT

Over a coaxial cable network, remotely instruct a first network element that provides AC power to a second network element over the coaxial cable network, to turn off downstream AC power to the second network element. The second network element is not collocated with the first network element. Perform at least one function related to the second network element while the AC power is turned off. Following completion of the at least one function related to the second network element, remotely instruct the first network element, over the coaxial cable network, to turn on the downstream AC power.

### FIELD OF THE INVENTION

The present invention relates generally to the electrical, electronic and computer arts, and, more particularly, to electronic devices, networking, and network management.

### BACKGROUND OF THE INVENTION

As cable network (e.g., hybrid fiber-coaxial (HFC) or “pure” cable) operators accelerate their network upgrade efforts, it is apparent that significant physical infrastructural upgrades will typically be needed. Physical upgrades, however, are cumbersome, time consuming, customer impacting, and require multiple resources to be achieved successfully. For instance, for a single active or passive upgrade/replacement, HFC operators must dispatch at least two technicians to follow proper installation and safety guidelines. One technician drives to the preceding (upstream) active component and accesses it by opening the lid of the upstream active component. Then, this first technician disconnects AC power by removing the appropriate output shunt or fuse. A second technician locates the next (downstream) active component in a design map, drives to the location (or phones another technician with directions) and opens the lid of the downstream active component. Then, the second technician removes the module to be upgraded/replaced and safely installs a new one. As soon as the installation of the new module is completed, the first technician restores the AC output power by re-installing the AC fuse or shunt for the preceding active component. With AC power restored, the second technician activates AC power at the input of the new module by installing the fuse at the input, and measures the signal strength. The upgraded/replaced active component is then balanced to restore service. Note that, as will be appreciated by the skilled artisan from the context, “active” is used in some instances herein as a shorthand for an active component or the like, and “passive” is used in some instances herein as a shorthand for a passive component or the like.

### SUMMARY OF THE INVENTION

Principles of the invention provide a remote AC power control system for cable network maintenance. In one aspect, an exemplary method includes the operations of, over a coaxial cable network, remotely instructing a first network element that provides AC power to a second network element over the coaxial cable network, to turn off downstream AC power to the second network element, wherein the second network element is not collocated with the first network element; performing at least one function related to the second network element while the AC power is turned off; and, following completion of the at least one function related to the second network element, remotely instructing the first network element, over the coaxial cable network, to turn on the downstream AC power.

In another aspect, an exemplary active network element includes a coaxial input configured to input RF and AC from upstream coaxial cable; a coaxial output configured to output RF and AC to downstream coaxial cable; an AC bus coupling the coaxial input and the coaxial output; an AC switch configured to interrupt AC through the AC bus; an amplifier interface coupled to the AC switch and configured to receive, over at least one of the coaxial input and the coaxial output, instructions to control the AC switch; and a power supply configured to obtain AC power from the upstream coaxial cable and provide DC power to the AC switch.

In still another aspect, an exemplary system includes a memory; and at least one processor, coupled to the memory, and operative to receive first instructions for a first network element that provides AC power to a second network element over a coaxial cable network, to turn off downstream AC power to the second network element, wherein the second network element is not collocated with the first network element; responsive to receiving the first instructions, instruct the first network element, over the coaxial cable network, to turn off the downstream AC power; following completion of at least one function related to the second network element, receive second instructions for the first network element to turn the downstream AC power to the second network element back on; and, responsive to receiving the second instructions, instruct the first network element, over the coaxial cable network, to turn the downstream AC power back on.

In a further aspect, an exemplary non-transitory computer readable medium includes computer executable instructions which when executed by a processor cause the processor to perform the method of: receiving first instructions for a first network element that provides AC power to a second network element over a coaxial cable network, to turn off downstream AC power to the second network element, wherein the second network element is not collocated with the first network element; responsive to receiving the first instructions, instructing the first network element, over the coaxial cable network, to turn off the downstream AC power; following completion of at least one function related to the second network element, receiving second instructions for the first network element to turn the downstream AC power to the second network element back on; and, responsive to receiving the second instructions, instructing the first network element, over the coaxial cable network, to turn the downstream AC power back on.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps (or a system wherein one or more such apparatuses are networked together, optionally with one or more other components). Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
techniques for upgrading/replacing active and passive components with reduced human resources, less time required for implementation, and/or reduced system downtime.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 illustrates the components and function of an HFC active component with an integrated remote AC switching system, in accordance with aspects of the invention;

FIG. 11 shows a sample user interface for a smartphone application to control the AC output power switch of an HFC active device, in accordance with aspects of the invention;

FIG. 12 illustrates a remote AC interface pluggable module for first generation ESD (extended spectrum DOCSIS, also called DOCSIS 4.0 frequency division duplexing, or FDD) HFC actives that do not have an AC switch system integrated, in accordance with aspects of the invention;

FIG. 13 depicts a first generation ESD HFC active (e.g., amplifier), which does not have an AC switch system integrated, and with the pluggable module installed for remote AC output power control, in accordance with aspects of the invention;

FIG. 14 is a flowchart for an example method for operating the remote AC powering system, in accordance with aspects of the invention;

FIG. 15 illustrates the components and function of an HFC active component similar to FIG. 10, with additional exemplary details, in accordance with aspects of the invention; and

FIG. 16 is an exemplary block diagram of a smart phone or similar device useful in connection with aspects of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present disclosure will be described herein in the context of apparatus, systems, and methods for electronic devices, networking, and network management. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

One or more embodiments can be employed to remotely control AC power to safely conduct maintenance in cable networks. One non-limiting example of such a network is a hybrid fiber-coaxial (HFC) network; other non-limiting examples include “pure” cable networks. Cable networks and the like can, in some instances, deliver video programs as well as data; the skilled artisan will understand from the context whether a “program” refers to a video program or a computer program.

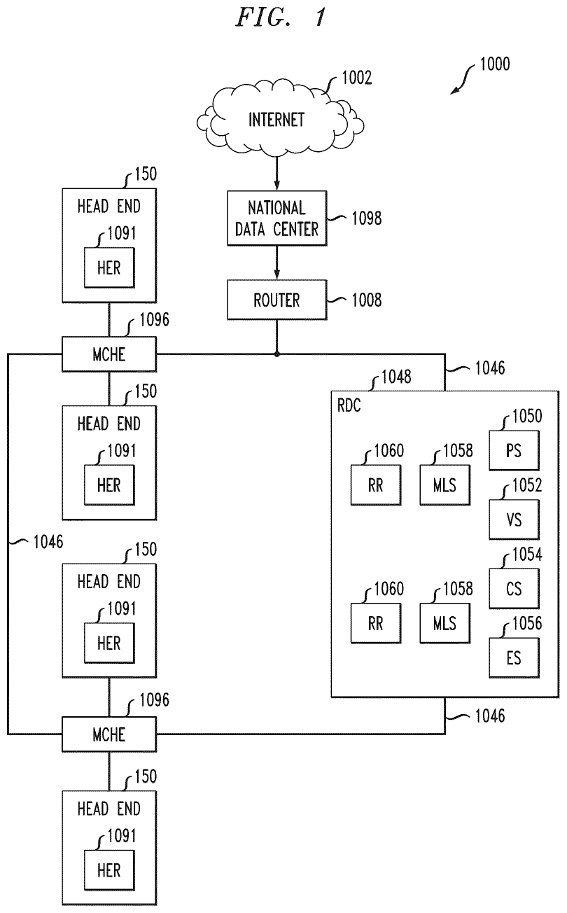

Thus, purely by way of example and not limitation, a description will be provided of a cable multi-service operator (MSO) providing data services as well as entertainment services, as an example environment in which aspects of the invention could be employed, it being understood that aspects of the invention could be employed in different network environments. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

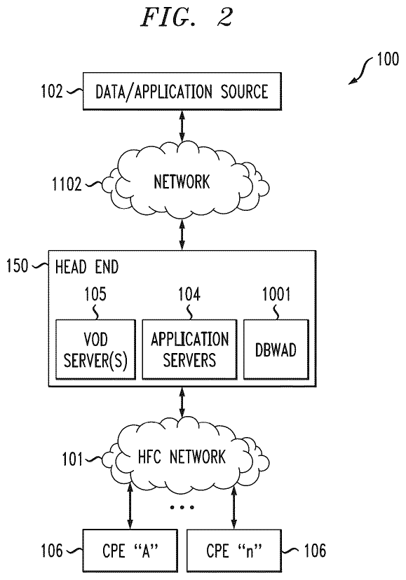

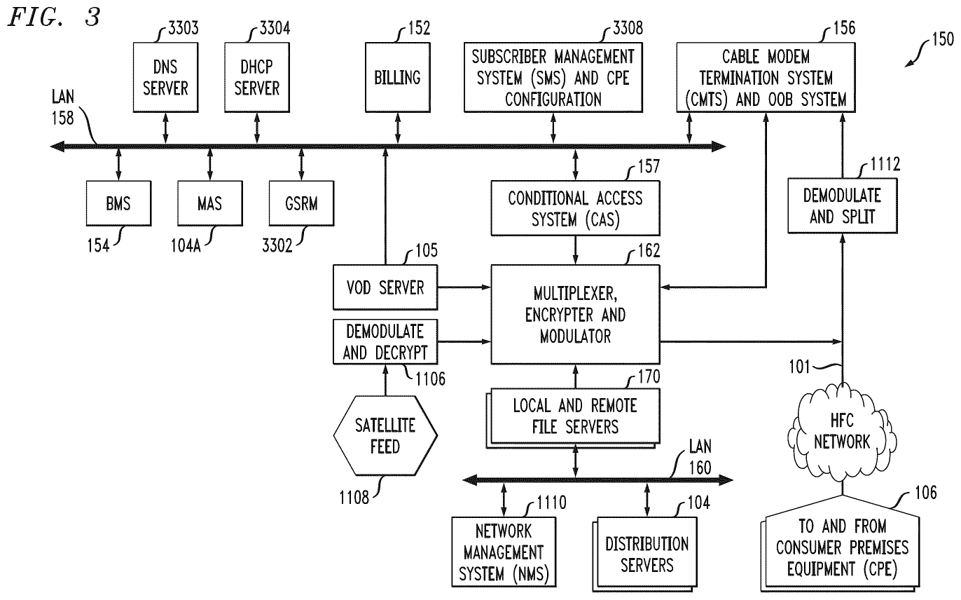

FIG. 2 is a functional block diagram illustrating an exemplary content-based (e.g., hybrid fiber-coaxial (HFC)) divisional network configuration, useful within the system of FIG. 1. See, for example, U.S. Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

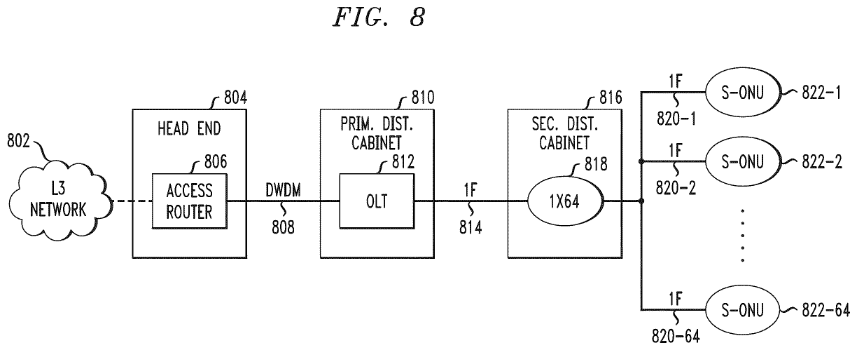

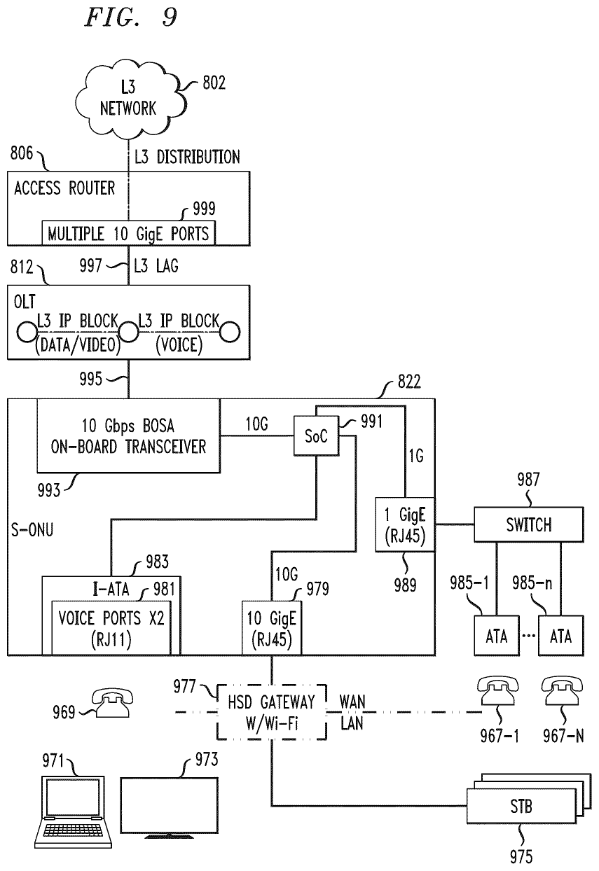

The CPE 106 includes any equipment in the “customers'premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

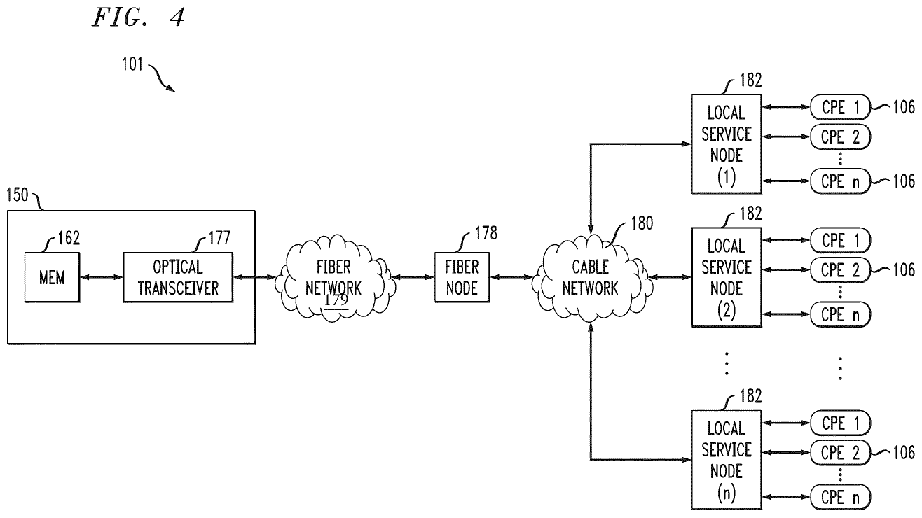

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to U.S. Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. U.S. Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention” it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

U.S. Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

U.S. Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in U.S. Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

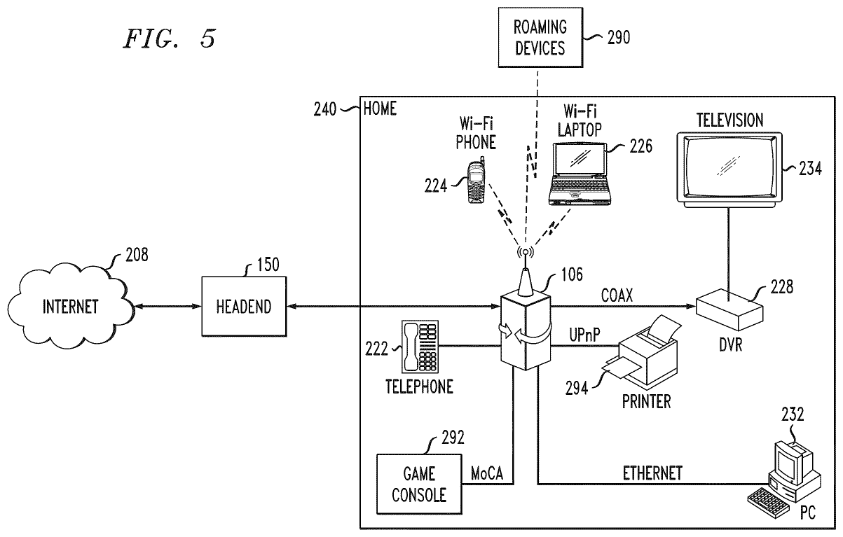

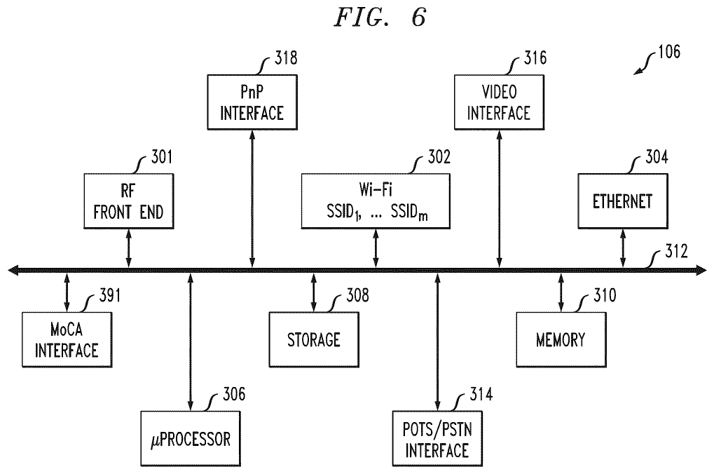

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment—see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as, for example, packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

One or more embodiments are applicable to cable networks, as noted. Cable MSOs may also have portions of the network implemented as fiber networks for fiber to the home (FTTH) deployments (also known as fiber to the premises or FTTP), where the CPE is a Service ONU (S-ONU; ONU=optical network unit). A description of same is now provided for completeness, it being understood that one or more embodiments are applicable to cable networks. Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

As operators implement Distributed Access Architecture (DAA) and full DOCSIS® (Data Over Cable Service Interface Specification) 4.0 upgrades, both active and passive components typically need to be upgraded. With millions of passive components in a large HFC system, interrupting AC becomes more critical since RPDs (Remote PHY Devices, PHY is in reference to the Physical Layer of the well-known OSI 7-Layer reference model) are susceptible to AC spikes causing the RPD to reset, which can take up to ten minutes to reboot and for modems, which may take 30 minutes to be restored online.

Moreover, physical upgrades in HFC systems are cumbersome, time consuming, customer impacting, and typically require multiple resources to be achieved successfully. For instance, for a single active or passive component upgrade/replacement, HFC operators usually must dispatch at least two technicians to follow proper installation and safety guidelines. During a high-split HFC upgrade, for example, several technicians are needed; the upgrade can take long hours of service interruption since, in a typical node with four active legs, each leg typically has several actives and several passives down the line.

In cable networks, the low-split configuration utilizes the 5-42 MHz spectrum on the return path (upstream); a guard region is present from 42-52 MHz, and from 52 MHz up is downstream traffic. A high-split configuration (designed to increase upstream capacity), alternatively, utilizes 5-204 MHz spectrum on the return path; a guard band is present from 204-258 MHz, and from 261 MHz up is downstream (e.g., video) traffic. Note that 204-258 MHz is the DOCSIS 3.1 and 4.0 high-split guard band.

Currently, the location where the AC can be shut off for purposes of working on a network component is not collocated with the network component to be worked on, and could be, for example, one hundred feet (about thirty meters) or even one mile (about 1.6 kilometers) away.

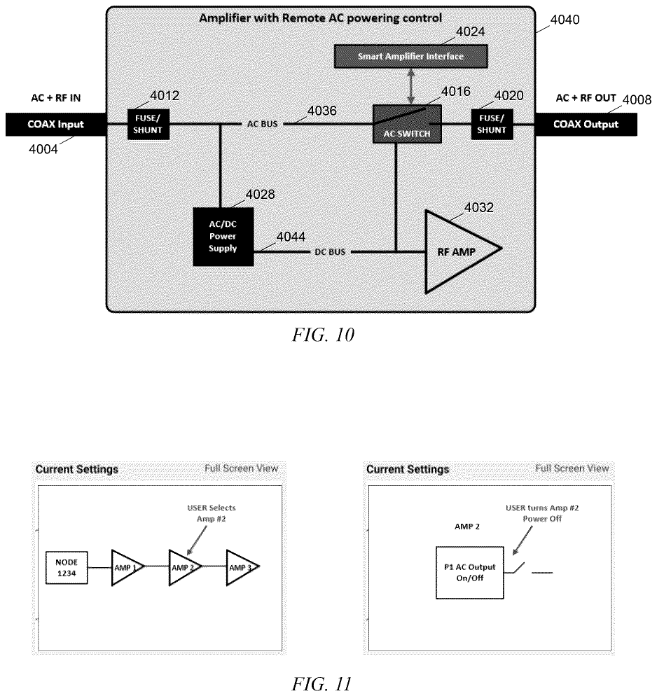

Referring now to FIG. 10, in example embodiments, an electronic AC switch system works in conjunction with smart amplifier technology and takes advantage of the introduction of smart HFC active technology (i.e., “new” component with built-in switch and smart amplifier interface). FIG. 10 illustrates the components and function of an HFC active 4040 (in the non-limiting example, an amplifier), with an integrated remote AC switching system. Coaxial input 4004 provides AC power and RF signals when fuse/shunt 4012 is closed, while coaxial output 4008 passes AC power and RF signals downstream when fuse/shunt 4020 is closed. As illustrated in FIG. 10, the HFC active component 4040 has an AC power bus 4036 that enables AC power flow to be set via manual shunt/fuses 4012, 4020 at the input 4004 and output 4008, respectively, of the active 4040. The AC power bus 4036 powers the AC/DC internal power supply 4028 that provides DC voltage to the active components within the housing, such as an RF amplifier 4032. An AC switch 4016 (which could be, for example, electronic or electro-mechanical) is integrated into the active AC power bus 4036, controlling the flow of alternating current (AC) in active devices, such as nodes and amplifiers 4032, at the output ports independently. In some exemplary embodiments, the AC switch 4016 operates electronically, relying on semiconductor components rather than mechanical ones to perform switching functions. Integrating the AC switch 4016 (which is controlled by a smart amplifier interface 4024) allows the user to remotely set the AC switch 4016 to the “ON” position to pass AC to the output leg (such as output 4008) or the “OFF” position to not allow AC to pass. The AC switch 4016 is powered via the DC bus 4044 of the HFC active component 4040.

In example embodiments, the smart amplifier interface 4024 is based on AMERICAN NATIONAL STANDARD ANSI/SCTE 283 2023 Information Model for Smart Broadband Amplifiers, 2023, Society of Cable Telecommunications Engineers, Inc. Exton, PA, USA, known to the skilled artisan, and hereby expressly incorporated by reference herein, which enables telemetry to control attributes and parameters within the HFC active component 4040 (e.g., amplifier). One or more embodiments make use of smart amplifier interface transponder, which is a technology to communicate between the smart amplifier interface and external components via the coaxial cable, using LoRaWAN® protocols (registered mark of Semtech Corporation, Camarillo, CALIFORNIA UNITED STATES) or Hybrid Management Sub-Layer (HMS), back upstream using RF signals over coax, and then to a node, back to a hub site, and ultimately to a cloud server. See discussion of element 4997 below. The skilled artisan will be familiar with Hybrid Management Sub-Layer (HMS) from, for example, AMERICAN NATIONAL STANDARD ANSI/SCTE 25-1 2017(R2022 ), Hybrid Fiber Coax Outside Plant Status Monitoring—Physical (PHY) Layer Specification v1, SCTE 2022, expressly incorporated herein by reference in its entirety for all purposes, and AMERICAN NATIONAL STANDARD ANSI/SCTE 25-2 2017(R2022 ), Hybrid Fiber Coax Outside Plant Status Monitoring—Media Access Control (MAC) Layer Specification v1.0, SCTE 2022, also expressly incorporated herein by reference in its entirety for all purposes. Given the teachings herein, the skilled artisan will be able to adapt aspects of HMS to implement one or more embodiments of the invention. The skilled artisan will be familiar with the LoRaWAN® protocols from, for example, L2 1.0.4 Specification (TS001-1.0.4) Version: 1.0.4, LoRa Alliance Technical Committee October 2020, expressly incorporated herein by reference in its entirety for all purposes. Given the teachings herein, the skilled artisan will be able to adapt aspects of the LoRaWAN® protocols to implement one or more embodiments of the invention.

In example embodiments, the implementation of the electronic AC switch 4016 includes, at a basic level, a semiconductor device including a control circuit to generate the signals needed to turn the semiconductor devices on and off. In addition, in one or more embodiments, a snubber circuit (a circuit that controls circuit reactance effects) is configured to protect the semiconductor devices from voltage spikes and a heat sink is configured to dissipate the heat generated by the semiconductor components. The skilled artisan will have general familiarity with heat sinks for amplifiers and other active components. In one or more embodiments, the snubber circuit is located before the AC switch, and the snubber circuit is on the same board as the control and switch circuit, as discussed further just below. The skilled artisan is familiar with a variety of suitable discrete or integrated snubber circuits that can be employed.

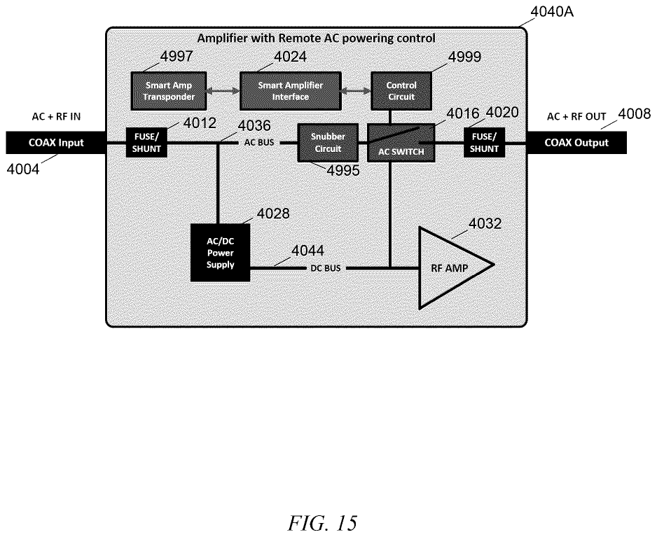

FIG. 15 illustrates the components and function of an HFC active component 4040A similar to active component 4040 of FIG. 10, with additional exemplary details, in accordance with aspects of the invention. Similar elements have received the same reference number. Note the snubber circuit 4995 located before the AC switch 4016; control circuit 4999; and smart amp transponder 4997. Element 4024 can be implemented, for example, using a microcontroller and communication bus inside the amplifier 4040A. Element 4997 can be, for example, a hardware transceiver using HMS and/or LoRaWAN®, that is integrated in the amp module 4040A or can be a stand-alone device; in one or more embodiments, it is the device that transfers the data from the amplifier to the server. Given the teachings herein, the skilled artisan will be able to implement elements 4024 and 4997.

When the user signals the electronic AC switch 4016 to switch ON, the control circuit 4999 sends a signal to the gate (or other relevant terminal) of the corresponding semiconductor device (e.g., turning on a field effect transistor (FET) by applying the appropriate signal to the gate in a known manner, or turning on a BJT in a known manner). The controller 4999 can include, for example, a microcontroller, one or more processors and memory devices, one or more application specific integrated circuits, and/or other control circuits configured to control the AC switch based on information and parameters received from the user interface. The controller can send control signals (e.g., via the amplifier control bus) to control and/or configure the AC switch state. The transponder can communicate with the controller via a smart amplifier interface communication link. The communication link can be any suitable wired and/or wireless communication link. In some embodiments the communication link can include one or more of a universal serial bus (USB-C) communication link, a serial communication link, an Ethernet communication link, or other suitable communication link. The communication link can include communication over one or more networks, including one or more local area networks, wide area networks/internetworks (e.g., the Internet), private networks, controller area networks (CAN), or other networks.

Controller 4999 can implement the logic discussed herein using custom digital circuitry (e.g., CMOS logic); some or all aspects could alternatively be implemented in software, firmware, an ASIC, an FPGA, or the like. Given the teachings herein, the skilled artisan can use known techniques to synthesize digital circuitry to implement the controller 4999/microcontroller of element 4024/transponder 4997, and the like.

The semiconductor device (e.g., FET) then transitions to an ON (conducting) state, allowing current to flow through it. It remains in this state, in the case of a FET, as long as the gate-source voltage, v_{GS}, has the appropriate value with respect to threshold voltage, vₜ (greater than threshold voltage for n-channel, less than threshold voltage for p-channel.). When the user signals the electronic AC switch 4016 to switch OFF, the control circuit stops the triggering signal to stop the conduction of current to the semiconductor device. Other embodiments can use switches other than FETs; e.g., an appropriately biased npn or pnp bipolar junction transistor (BJT).

FIG. 11 shows two example screens for a user interface for a smartphone application to control the AC output power switch 4016 of an HFC active component, in accordance with example embodiments. In the example of FIG. 11, the HFC active component is an amplifier unit 4040, 4299. The screenshot on the left shows an example interface that enables a user to select the specific amplifier to turn the AC power in the output leg to the “ON” or “OFF” position. The screenshot on the right shows an example interface that enables a user to set the AC switch 4016 to the “ON” or “OFF” position.

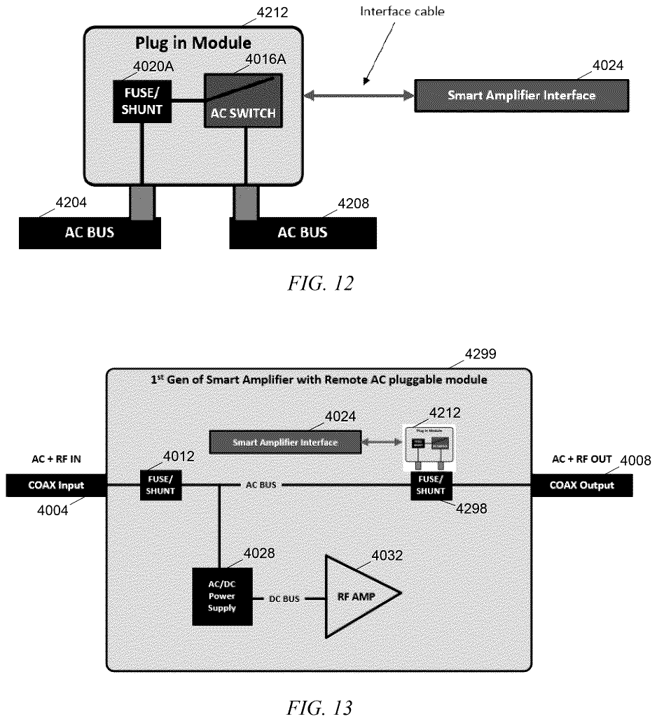

FIG. 12 illustrates a remote AC interface pluggable module 4212 for HFC active components, in accordance with example embodiments. The electronic pluggable 4212 provides flexibility and backward compatibility with the first generation of smart actives (which is advantageous). The pluggable 4212 is installed, for example, as part of a retrofit, in the pre-existing fuse/shunt receptacle on the output port of a “legacy” amplifier or other active component and provides similar functionality to the integrated AC switch 4016 and fuse/shunt 4020 described above. The upstream portion of the AC bus is designated as 4204 and the downstream portion of the AC bus is designated as 4208. The remote AC interface pluggable module 4212 is useful for HFC active components that do not have an integrated AC power switch 4016. The pluggable module 4212 fits directly in the pre-existing fuse/shunt receptacle that are in all traditional HFC active components. In example embodiments, the form factor of the pluggable module 4212 is that of a standard automotive fuse or mini-automotive fuse (depending on the legacy HFC active fuse port size). The pluggable module 4212 includes an AC power switch 4016A and a fuse/shunt 4020A. In one or more embodiments, the AC pluggable module 4212 connects to the smart amplifier interface 4024 via an interface cable to an external port connection (for example, Universal Serial Bus Type-C (USB-C)).

In example embodiments, the electronic pluggable 4212 is controlled by a smart amplifier interface 4024 via, for example, an external cable (such as a USB-C cable), as just discussed. The external cable also provides the direct current required to power the semiconductor components in the electronic pluggable 4212. Therefore, as with the integrated switch solution, a single technician can safely perform a single upgrade/replacement of an HFC network component (passive or active). In one or more embodiments, the pluggable is limited to an AC pluggable because AC is what is passed in the coaxial cable, and the AC is only rectified locally in the power supply.

FIG. 13 depicts a legacy HFC active component 4299 with the pluggable module 4212 installed for remote AC output power control, in accordance with example embodiments. The pluggable module 4212 is installed in a fuse/shunt receptacle 4298 and is connected to the smart amplifier interface 4024 via an external USB-C cable or the like, as discussed. The USB-C cable also provides the DC powering (12 volts, 24 volts and the like) to the pluggable module 4212.

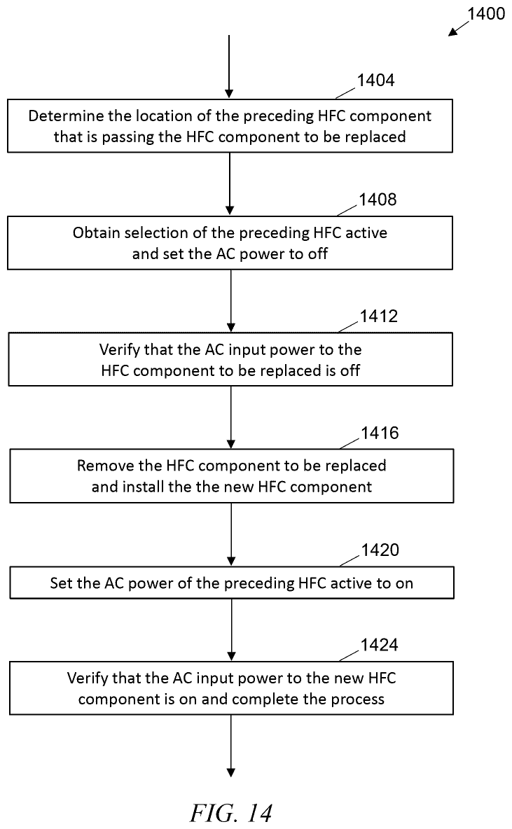

FIG. 14 is a flowchart for an example method 1400 for operating the remote AC powering system, in accordance with example embodiments. Typically but optionally, a user initially proceeds to a location of the HFC active or passive component that will be replaced. In one example embodiment, a location of the preceding HFC active component that is passing AC power to the HFC component that is to be replaced is determined using HFC design maps or other HFC network topology tool (optionally integrated with the smartphone application)(operation 1404). The user selects the preceding HFC active component and sets the AC power output to “OFF” using, for example, the smart phone application (operation 1408). The user verifies that the AC input power is OFF at the replacement location using, for example, a voltmeter (operation 1412). The user safely removes the HFC component from the hardline coax cable and installs the new component (operation 1416). Once the replacement is complete, the user employs, for example, the smart phone application to turn the output power of the preceding HFC active component back to the “ON” position (operation 1420). The user validates that AC power is restored to the replaced component and completes any remaining post power-on steps of the HFC component installation (operation 1424).

It is noted that the above-described techniques can be used to upgrade/replace other components, including cables, passive components (e.g., taps, directional couplers, splitters), fittings, and the like. For example, a cable or passive component located downstream from the AC power switch 4016 can be upgraded/replaced using the above-described techniques.

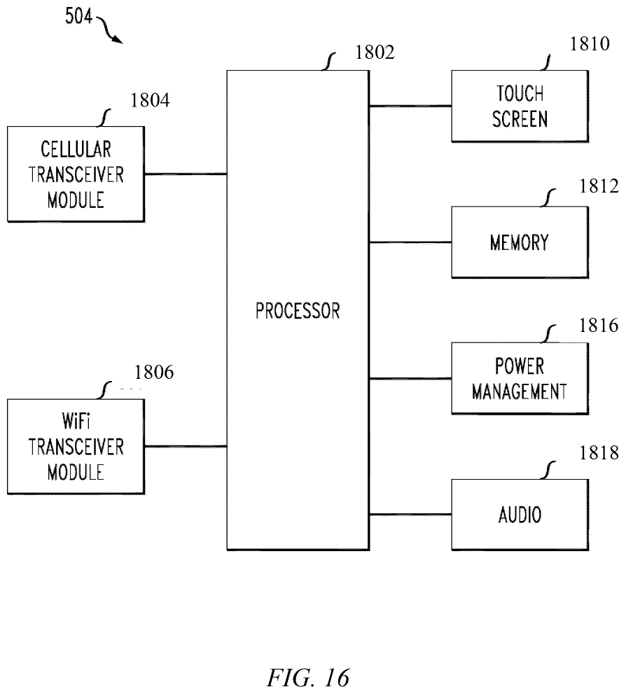

FIG. 16 is a block diagram of an exemplary tablet computing device or smart phone or the like (“device”) useful in connection with aspects of the invention. Device 504 includes a suitable processor; e.g., a microprocessor 1802. A cellular transceiver module 1804 coupled to processor 1802 includes an antenna and appropriate circuitry to send and receive cellular telephone signals, e.g., 3G, 4G, 5G, . . . A Wi-Fi transceiver module 1806 coupled to processor 1802 includes an antenna and appropriate circuitry to allow device 504 to connect to the Internet via a wireless network access point or hotspot. The skilled artisan will appreciate that “Wi-Fi” is a trademark of the Wi-Fi Alliance and the brand name for products using the IEEE 802.11 family of standards.

In one or more embodiments, one or more applications in memory 1812, when loaded into RAM cause the processor 1802 to implement aspects of the functionality described herein.

Touch screen 1810 coupled to processor 1802 is also generally indicative of a variety of devices such as a keypad, another type of display, a mouse or other pointing device, and so on, all of which may or may not be present in one or more embodiments. Memory 1812 is coupled to processor 1802. Audio module 1818 coupled to processor 1802 includes, for example, an audio coder/decoder (codec), speaker, headphone jack, microphone, and so on. Power management system 1816 can include a battery charger, an interface to a battery, and so on.

Embodiments of the invention are not limited to this particular form of device, exemplary devices include so-called smart phones, tablets, other types of portable electronic device having wireless connectivity, and the like.

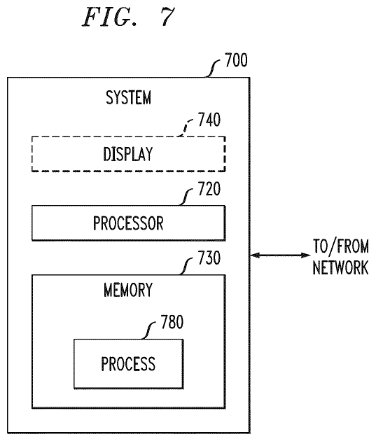

In one or more embodiments, an application “app” residing in memory 1812 configures the processor 1802 to implement aspects of the invention. Currently, amplifier vendors provide apps that can enable communication from a device 504 to an adjacent amplifier using a “dongle” plugged into the amplifier to establish a local Bluetooth/Wi-Fi connection from the cell device to the amplifier. Such current techniques do not enable communication from a device 504 adjacent a first amplifier to a remote, upstream amplifier, to shut off power. Referring to FIG. 1, in a location such as NDC 1098 or the like, there is an interface to one or more cellular networks, generally to the telephone system, or the like. A server such as system 700 in FIG. 7, which can optionally be collocated with the interface in the NDC 1098, communicates with the app in memory 1812 over the cellular network and communicates with the amplifiers over the HFC network, using elements 4997 and/or 4024, for example. The app in memory 1812 logs into the server in NDC 1098 which in turn communicates to the upstream amplifier, to turn off the AC switch in the upstream amplifier. In a non-limiting example, the transponder 4998, permits communication between the smart amplifier interface 4024 and external components via the coaxial cable, using LORAWAN or HMS, back upstream using RF signals over the coax, and then to a node 178, back to a hub site, and ultimately to a cloud server in the NDC 1098. Other approaches could be used; for example, instead of device 504 communicating with the server in the NDC 1098 via telephone, the “dongle” approach could be modified to allow the device 504 to communicate with the server in the NDC 1098 over the HFC network (at least while the amplifier is powered on).

Given the discussion thus far, it will be appreciated that, in general terms, an exemplary method, according to an aspect of the invention, includes the step of, over a coaxial cable network (e.g., HFC or “pure” coaxial), remotely instructing a first network element (e.g., upstream amplifier) that provides AC power to a second network element (e.g., downstream amplifier) over the coaxial cable network, to turn off downstream AC power to the second network element, wherein the second network element is not collocated with the first network element. It is worth noting that optionally, the first network element that provides the AC power to the second network element over the coaxial cable network is identified, as described with regard to FIG. 11, or using manual techniques such as referring to a paper or electronic plan of the coaxial cable network.

Further steps include performing at least one function related to the second network element (e.g., a maintenance action on the second network element) while the AC power is turned off, and, following completion of the at least one function related to the second network element, remotely instructing the first network element, over the coaxial cable network, to turn on the downstream AC power.

Optionally, the method is performed by a single technician, while at least partially located at the second network element, without physically visiting the location of the first network element; i.e., the technician performs at least some portion of the method while at the location of the second network element and does not physically visit the location of the first network element.

The second network element can be, for example, an active network component or a passive network component. In some instances, the second network element includes at least one of a coaxial cable fitting and a coaxial cable segment.

In some instances, the first network element includes an amplifier.

In one or more embodiments, the at least one maintenance function includes one of repair and replacement.

In some cases, the first network element includes a legacy element (e.g., a first generation ESD HFC active (e.g., amplifier), which does not have an AC switch system integrated). A further step includes, prior to the step of remotely instructing, retrofitting the first network element with a plug-in module including a switch to turn the AC power off and on and an interface to receive the remote instructions over the coaxial cable network, where the plug-in module is plugged into a fuse receptacle of the first network element. Refer to FIG. 13 and accompanying text.

In some cases, a further step includes, prior to the step of remotely instructing, installing the first network element to the coaxial cable network with a switch to turn the AC power off and on and an interface to receive the remote instructions over the coaxial cable network. Refer to FIGS. 10 and 15 and accompanying text.

In one or more embodiments, the remote instructing is carried out using a smart phone application.

In some cases, the remote instructing includes, with an application on a wireless device 504, communicating with a back-end server (e.g., system 700 in an NDC as discussed) of the coaxial cable network (e.g., at least in part over a cellular network), and in response, the back-end server of the coaxial cable network remotely instructing the first network element over the coaxial cable network.

In some cases, the remote instructing includes, with an application on a wireless device 504, wirelessly communicating with the second network element (e.g., use a “dongle” as discussed elsewhere but expand the capability to control a remote amplifier). Further steps include, in response to the wireless communication, the second network element communicating with a back-end server (e.g., system 700 in an NDC as discussed) of the coaxial cable network over the coaxial cable network, and, in response to the communication with the back-end server, the back-end server remotely instructing the first network element over the coaxial cable network. It should be understood that this aspect is appropriate to shut the power off, but once the unit is powered down, it typically cannot be used for further communication so the command to restore power would appropriately be sent using the cellular network. That is to say, in this aspect, power could be shut down via transponder communication but in this case would be restored via the cell network.

In this regard, consider generally the communication between the smart amplifier interface and external components via the coaxial cable, using LORAWAN or HMS, back upstream using RF signals over coax, and then to a node, back to a hub site, and ultimately to a cloud server. In another aspect, instead of an app, communicate with the back-end server, for example, using a web browser and internet access over the cellular network.

In another aspect, an active network element 4040, 4040A, 4299 (e.g., upstream device, such as an amplifier unit or other unit including an amplifier, such as a node with an amp tray) where power is to be shut off) includes a coaxial input 4004 configured to input RF and AC from upstream coaxial cable (e.g., a hardline connector that connects directly onto the amp unit 4040, 4040A, 4299). Also included is a coaxial output 4008 configured to output RF and AC to downstream coaxial cable (e.g., a hardline connector that connects directly onto the amp unit 4040, 4040A, 4299). An AC bus 4036 (e.g., a wire trace on a printed circuit board) couples the coaxial input and the coaxial output. An AC switch 4016, 4016A (e.g., FET, BJT, electro-mechanical) is configured to interrupt AC through the AC bus. An amplifier interface 4024 is coupled to the AC switch and is configured to receive, over at least one of the coaxial input and the coaxial output, instructions to control the AC switch. An RF amplifier 4032 is provided in at least some instances (e.g., known amplifier circuit). A power supply 4028 (e.g., known power supply circuit) is configured to obtain AC power from the upstream coaxial cable and provide DC power to the AC switch (and, where present, to the RF amplifier).

In some cases, the coaxial input, the coaxial output, the AC bus, the RF amplifier, and the power supply are at least a portion of a legacy network element (e.g., a first generation ESD HFC active (e.g., amplifier), which does not have an AC switch system integrated); and the AC switch is retrofitted in a fuse socket of the AC bus, as per FIG. 13.

On the other hand, in some cases, the coaxial input, the coaxial output, the AC bus, the AC switch, the amplifier interface, the RF amplifier, and the power supply are at least a portion of an integrally pre-assembled network element, as per FIGS. 10 and 15.

In another aspect, an exemplary system includes a memory 730; and at least one processor 720, coupled to the memory, and operative to receive first instructions for a first network element that provides AC power to a second network element over a coaxial cable network, to turn off downstream AC power to the second network element. The second network element is not collocated with the first network element. The at least one processor is further operative to, responsive to receiving the first instructions, instruct the first network element, over the coaxial cable network, to turn off the downstream AC power; following completion of at least one function related to the second network element, receive second instructions for the first network element to turn the downstream AC power to the second network element back on; and, responsive to receiving the second instructions, instruct the first network element, over the coaxial cable network, to the downstream AC power back on.

One or more embodiments further include the first network element, the second network element, and the coaxial cable network. The coaxial cable network is coupled to the first network element, the second network element, and the at least one processor. The network elements can be located at any suitable location in the coaxial portion of FIG. 4, for example.

In one or more embodiments, the second network element includes an active network component; in other embodiments, the second network element includes a passive network component. In a practical network, there can typically be a mix of active and passive components.

In some cases, the second network element includes at least one of a coaxial cable fitting and a coaxial cable segment.

In one or more embodiments, the first network element includes an amplifier.

In some instances, the first network element includes a legacy element 4299 (e.g., a first generation ESD HFC active (e.g., amplifier), which does not have an AC switch system integrated), retrofitted with a plug-in module including a switch to turn the AC power off and on and an interface to receive the remote instructions over the coaxial cable network. The plug-in module is plugged into a fuse receptacle of the first network element.

In other instances, the first network element 4040, 4040A includes an integrated switch 4016 to turn the AC power off and on and an interface 4024 to receive the remote instructions over the coaxial cable network.

In some cases, the at least one processor is configured to receive the first and second instructions from a smart phone application.

In some instances, the memory and the at least one processor are at least a portion of a back-end server of the coaxial cable network. In some such cases, the at least one processor is configured to receive the first and second instructions from the smart phone application via cellular communication. On the other hand, in other such cases, the at least one processor is configured to receive the first instructions from the smart phone application via communication with the second network element. As noted above, it should be understood that this aspect is appropriate to shut the power off, but once the unit is powered down, it typically cannot be used for further communication so the command to restore power would appropriately be sent using the cellular network.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
over a coaxial cable network, remotely instructing a first network element that provides AC power to a second network element over the coaxial cable network, to turn off downstream AC power to the second network element, wherein the second network element is not collocated with the first network element;
performing at least one function related to the second network element while the AC power is turned off; and
following completion of the at least one function related to the second network element, remotely instructing the first network element, over the coaxial cable network, to turn on the downstream AC power.

2. The method of claim 1, wherein the at least one function comprises a maintenance function on the second network element.

3. The method of claim 2, wherein the method is performed by a single technician, while at least partially located at the second network element, without physically visiting a location of the first network element.

4. The method of claim 3, wherein the second network element comprises an active network component.

5. The method of claim 3, wherein the second network element comprises a passive network component.

6. The method of claim 3, wherein the second network element comprises at least one of a coaxial cable fitting and a coaxial cable segment.

7. The method of claim 3, wherein the first network element comprises an amplifier.

8. The method of claim 3, wherein the at least one maintenance function comprises one of repair and replacement.

9. The method of claim 3, wherein the first network element comprises a legacy element, further comprising, prior to the step of remotely instructing, retrofitting the first network element with a plug-in module including a switch to turn the AC power off and on and an interface to receive the remote instructions over the coaxial cable network, the plug-in module being plugged into a fuse receptacle of the first network element.

10. The method of claim 3, further comprising, prior to the step of remotely instructing, installing the first network element to the coaxial cable network with a switch to turn the AC power off and on and an interface to receive the remote instructions over the coaxial cable network.

11. The method of claim 3, wherein the remote instructing is carried out using a smart phone application.

12. The method of claim 11, wherein the remote instructing comprises:
with an application on a wireless device, communicating with a back-end server of the coaxial cable network; and
in response, the back-end server of the coaxial cable network remotely instructing the first network element over the coaxial cable network.

13. The method of claim 11, wherein the remote instructing comprises:
with an application on a wireless device, wirelessly communicating with the second network element;
in response to the wireless communication, the second network element communicating with a back-end server of the coaxial cable network over the coaxial cable network; and
in response to the communication with the back-end server, the back-end server remotely instructing the first network element over the coaxial cable network.

14. An active network element, comprising:
a coaxial input configured to input RF and AC from upstream coaxial cable;
a coaxial output configured to output RF and AC to downstream coaxial cable;
an AC bus coupling the coaxial input and the coaxial output;
an AC switch configured to interrupt AC through the AC bus;
an amplifier interface coupled to the AC switch and configured to receive, over at least one of the coaxial input and the coaxial output, instructions to control the AC switch; and
a power supply configured to obtain AC power from the upstream coaxial cable and provide DC power to the AC switch.

15. The active network element of claim 14, further comprising an RF amplifier, wherein the power supply is further configured to provide DC power to the RF amplifier.

16. The active network element of claim 15, wherein:
the coaxial input, the coaxial output, the AC bus, the RF amplifier, and the power supply comprise at least a portion of a legacy network element; and
the AC switch is retrofitted in a fuse socket of the AC bus.

17. The active network element of claim 15, wherein:
the coaxial input, the coaxial output, the AC bus, the AC switch, the amplifier interface, the RF amplifier, and the power supply comprise at least a portion of an integrally pre-assembled network element.

18. A system comprising:
a memory; and
at least one processor, coupled to the memory, and operative to:
receive first instructions for a first network element that provides AC power to a second network element over a coaxial cable network, to turn off downstream AC power to the second network element, wherein the second network element is not collocated with the first network element;
responsive to receiving the first instructions, instruct the first network element, over the coaxial cable network, to turn off the downstream AC power;
following completion of at least one function related to the second network element, receive second instructions for the first network element to turn the downstream AC power to the second network element back on; and
responsive to receiving the second instructions, instruct the first network element, over the coaxial cable network, to turn the downstream AC power back on.

19. The system of claim 18, wherein the at least one function comprises a maintenance function on the second network element.

20. The system of claim 19, further comprising the first network element, the second network element, and the coaxial cable network, the coaxial cable network being coupled to the first network element, the second network element, and the at least one processor.

21. The system of claim 20, wherein the second network element comprises an active network component.

22. The system of claim 20, wherein the second network element comprises a passive network component.

23. The system of claim 20, wherein the second network element comprises at least one of a coaxial cable fitting and a coaxial cable segment.

24. The system of claim 20, wherein the first network element comprises an amplifier.

25. The system of claim 20, wherein the first network element comprises a legacy element, retrofitted with a plug-in module including a switch to turn the AC power off and on and an interface to receive the remote instructions over the coaxial cable network, the plug-in module being plugged into a fuse receptacle of the first network element.

26. The system of claim 20, wherein the first network element comprises an integrated switch to turn the AC power off and on and an interface to receive the remote instructions over the coaxial cable network.

27. The system of claim 20, wherein the at least one processor is configured to receive the first and second instructions from a smart phone application.

28. The system of claim 27, wherein:
the memory and the at least one processor are at least a portion of a back-end server of the coaxial cable network;
the at least one processor is configured to receive the first and second instructions from the smart phone application via cellular communication.

29. The system of claim 27, wherein:
the memory and the at least one processor are at least a portion of a back-end server of the coaxial cable network;
the at least one processor is configured to receive the first instructions from the smart phone application via communication with the second network element.

30. A non-transitory computer readable medium comprising computer executable instructions which when executed by a processor cause the processor to perform the method of:
receiving first instructions for a first network element that provides AC power to a second network element over a coaxial cable network, to turn off downstream AC power to the second network element, wherein the second network element is not collocated with the first network element;
responsive to receiving the first instructions, instructing the first network element, over the coaxial cable network, to turn off the downstream AC power;
following completion of at least one function related to the second network element, receiving second instructions for the first network element to turn the downstream AC power to the second network element back on; and
responsive to receiving the second instructions, instructing the first network element, over the coaxial cable network, to turn the downstream AC power back on.
